(19) United States
(12) Patent Application Publication
(10) Pub. No.: US 2012/0265374 A1
(43) Pub. Date: Oct. 18, 2012

(54) AIRCRAFT VERTICAL TRAJECTORY OPTIMIZATION METHOD

(76) Inventor: Thomas Edward Yochum, Kirkland, WA (US)

(21) Appl. No.: 13/087,794

(22) Filed: Apr. 15, 2011

(51) Int. Cl. G05D 1/06

(52) U.S. Cl. 701/5

(57) ABSTRACT

An target vertical trajectory for a flight plan is produced using aircraft performance characteristics taking into account only the altitude constraints, but ignoring any speed and time constraints. The target vertical trajectory is evaluated for violations of altitude, speed, and time constraints and on the basis of other criteria. An alternative vertical trajectory is generated by randomly changing parts of the target vertical trajectory, and this alternative is likewise evaluated. If the child vertical trajectory has a more robust evaluation, it becomes to new target vertical trajectory; otherwise the previous target vertical trajectory remains in place. The alternative vertical trajectory generation process is performed repeatedly and over time the target vertical trajectory evolves toward an optimum trajectory solution.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to a flight management system for an aircraft, and more particularly determining a target vertical trajectory for a given flight plan of the aircraft.

2. Description of the Related Art

A flight management system (FMS) is a fundamental component of the avionics on an aircraft. The FMS is a dedicated computer system that automates a wide variety of in-flight tasks, a primary one of which is in-flight management of the aircraft flight plan.

A navigation database, stored in the FMS, contains data for constructing the flight plan. That data include airways, waypoints, radio navigation aids (such as distance measuring equipment (DME), VHF omnidirectional range (VOR), and instrument landing systems), airports runways, runway approaches, and airport holding patterns. Another database stored in the FMS contains aircraft performance characteristics.

The flight plan is usually determined on the ground before departure, either by the pilot of smaller aircraft or by an airline dispatcher. The flight plan data then is entered into the FMS either via a cockpit keyboard, selection from a stored library of common routes, or via a datalink with the airline dispatch center. The flight plan includes the route, desired cruising altitude and desired cruising airspeed for each airway or segment of the route. During preflight other information relevant to managing the flight plan, such as gross weight of the aircraft, is entered into the FMS.

During flight, the FMS constantly crosschecks various on-board sensors to determine the aircraft's position and operating parameters. From that position and the stored flight plan, the FMS calculates the course to follow. The pilot can follow this course manually or the autopilot can be set to follow the course. The flight plan in the FMS often is modified during the flight by the pilot. In which case, the FMS has to rebuild flight plan information.

The flight plan route contains the lateral waypoints that will be used to fly between the departure and destination airports. Each lateral waypoint may have altitude and/or air speed constraints defined by the air traffic control system, which require that the aircraft upon reaching that position in the flight have an air speed within a defined range and have an altitude within a specified range. Air traffic controllers may also assign one time constraints to a waypoint requiring that the aircraft reach that position within a given interval of time, in order to facilitate spacing between aircraft flying similar routes. The three flight constraints of altitude, speed, and time are coupled together in the vertical domain based upon the aircraft's performance capabilities.

Sophisticated flight management systems compute an optimal flight trajectory that is to be flown based upon the aircraft's performance capabilities and the flight plan. That computation employs an algorithm that generates a target lateral trajectory and a target vertical trajectory which the aircraft is capable of performing and which meets all the lateral and vertical flight constraints. It is desirable that the algorithm provides target trajectories which are optimized to minimize the cost of the flight. This is traditionally done using a cost index, which is the ratio of time and fuel costs. The cost index function provides the speed which minimizes the total operation cost given the current aircraft weight.

The target lateral flight trajectory is independent of the aircraft's performance capabilities and is only loosely coupled to the target vertical trajectory via speed. The target lateral flight trajectory defines along track distances which in order to be accurate require the speed at each waypoint. Those speeds, however, are provided by the target vertical flight trajectory solution which requires accurate along track distances. Heretofore, this causality dilemma is solved by seeding one target flight trajectory with an approximate solution and then iterating between the solutions of the target lateral and vertical trajectories.

The conventional methods for determining a target trajectory are further complicated due to the fundamental flight constraints of altitude, speed, and time being interdependent and based upon the performance capabilities of the particular aircraft. As a result, adjusting a flight trajectory to meet one constraint may cause a different constraint to be violated. Therefore, the flight trajectory algorithms must take every possible constraint combination into account and address each constraint when deriving the vertical trajectory. When the entire flight performance envelope of an aircraft is considered, the resulting algorithm becomes massive, complex, and fragile. There is also the possibility of rare conditions or constraint combinations not being handled or being handled poorly.

### SUMMARY OF THE INVENTION

The present method involves solving for an optimal target vertical trajectory independently of the target lateral trajectory.

An initial target vertical trajectory is produced using aircraft performance characteristics taking into account only the altitude constraints. This method defines a series of points at distances along the flight route and a separate set of values for a plurality of aircraft parameters are determined at each of those points. The target vertical trajectory creation process ignores any speed and time constraints, thereby simplifying the derivation algorithm.

Upon completion, the “fitness” of the initial target vertical trajectory is evaluated using a predefined criteria. The fitness evaluation assigns penalty values based upon flight plan constraints being violated, the cost of the fuel consumed, the cost of the time to complete the flight, and how many control maneuvers (e.g. flight path angle and excess thrust changes) are used. The sum of all the penalty values indicates the relative fitness of a particular proposed vertical trajectory.

Next, an alternative target vertical trajectory is created by randomly changing (or mutating) parts of the initial target vertical trajectory, and this alternative is referred to as a “child vertical trajectory.” The fitness of the child vertical trajectory then is evaluated. If the child vertical trajectory has a more robust fitness, as indicated by a lower penalty value than the target vertical trajectory, the child trajectory becomes to new target vertical trajectory; otherwise the previous target vertical trajectory remains in place.

The algorithm repeats the child trajectory creation and evaluation process indefinitely. As a result, the target vertical trajectory evolves toward the optimum solution. This “genetic” target vertical trajectory derivation algorithm is far simpler than traditional methods, because less complex logic is required to solve for only one constraint and because of the use of random mutations to account for the other constraints and optimize the fuel and time costs.

### BRIEF DESCRIPTION OF THE DRAWINGS

FIG. 1 is a block diagram of a flight management system that implements the present method for determining a target vertical trajectory for the aircraft;

FIG. 2 is a graphical depiction of an exemplary target vertical trajectory;

FIG. 3 is a flowchart of the present method for iteratively determining the target vertical trajectory;

FIG. 4 is a flowchart of steps to produce an initial solution for the target vertical trajectory;

FIG. 5 is a flowchart of steps to produce a cost associated with a target vertical trajectory; and

FIG. 6 is a flowchart of steps to produce an alternative solution for the target vertical trajectory.

### DETAILED DESCRIPTION OF THE INVENTION

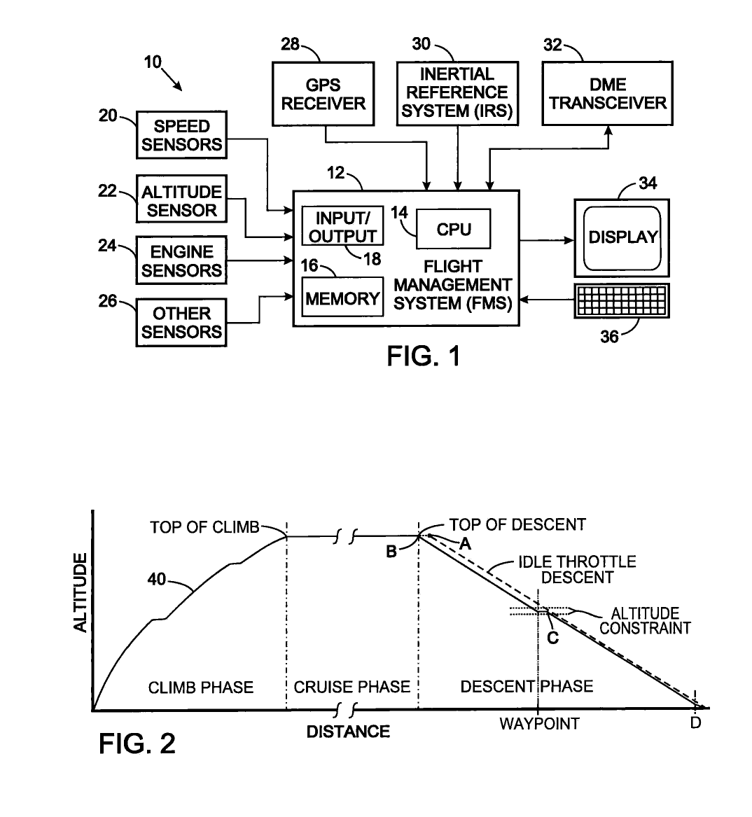

With initial reference to FIG. 1, the avionics 10 onboard an aircraft includes a flight management system (FMS) 12 that comprises a central processing unit (CPU) 14. The CPU 14 executes software that implements the flight management of the aircraft with which the FMS is used and that software includes a routine for deriving the vertical trajectory according to the present method. The software instructions for governing the operation of the FMS 12, data specifying performance characteristics of the aircraft, and other control data received and produced by the FMS are stored in a memory 16. The memory 16 comprises one or more of a random access memory, a CD-ROM, a hard disk, and other types of storage devices known in the art.

Input/output (I/O) circuits 18 interface the CPU 14 with several groups of sensors on the aircraft. The sensors, including speed sensors 20 for both the true airspeed and the vertical airspeed of the aircraft and an altitude sensor 22 are connected to inputs of the input/output circuits 18. Several conventional sensors 24 are provided to detect operating parameters of the aircraft engines as are other sensors 26 commonly used with flight management systems. The FMS 12 also receives data signals from components of the aircraft navigation system, that may include an inertial reference system (IRS) 28, global positioning satellite (GPS) receiver 30, and distance measuring equipment (DME) 32.

The flight crew of the aircraft interfaces with the flight management system 12 via a display device 34 and a keyboard 36. The keyboard 36 can be used to enter the aircraft flight plan into the FMS 12 and the display device 34 provides a visual depiction of the flight plan during air travel. Additional input/output devices may be provided to permit the flight crew to input data and commands into and receive information from the FMS.

The FMS 12 may be one of several models available from Universal Avionics Systems Corporation of Tucson, Ariz., U.S.A., for example. Such a conventional FMS is augmented with additional software to implement the present method for determining a target vertical trajectory for the aircraft, as described herein.

Prior to takeoff and as required thereafter during flight, the FMS constructs the flight plan for the aircraft. Part of the flight plan construction process involves creating a target vertical trajectory that thereafter is used to guide the aircraft. FIG. 2 depicts an example of a target vertical trajectory 40 which commences with a climb phase immediately after take-off. At the top of the climb, the aircraft enters the cruise phase during which a relatively constant cruising altitude is maintained. At the end of the cruise phase the aircraft reaches the top of descent point and begins a descent to land at the destination airport.

As a preface overview, the present method creates an initial target vertical trajectory using aircraft performance characteristics and taking into account only the altitude constraints along the flight path. That method defines a series of points spaced at equal distances along the flight route and the values for a plurality of aircraft parameters are determined at each of those points. Creation of the target vertical trajectory ignores any speed and time constraints, which simplifies the derivation algorithm. Upon completion, the “fitness” of the initial target vertical trajectory is evaluated. The fitness evaluation assigns a penalty value based upon flight plan constraints being violated, the cost of the fuel consumed, the cost of the time to complete the flight, and how many control maneuvers (e.g. flight path angle and excess thrust changes) are used.

Next, an alternative target vertical trajectory is created by randomly inserting small changes to parts of the initial target vertical trajectory, and this alternative is referred to as a child vertical trajectory. The fitness of the child vertical trajectory then is evaluated. If the child vertical trajectory has more robust fitness, as indicated by a lower penalty value than the target vertical trajectory, the child trajectory becomes the new target vertical trajectory; otherwise the previous target vertical trajectory remains in place.

The algorithm repeats the child trajectory creation and evaluation process indefinitely. As a result, the target vertical trajectory evolves toward the optimum solution. This “genetic” target vertical trajectory derivation algorithm is far simpler than traditional methods, because less complex logic is required to solve for only one constraint and because of the use of random mutations to account for the other constraints and optimize the fuel and time costs.

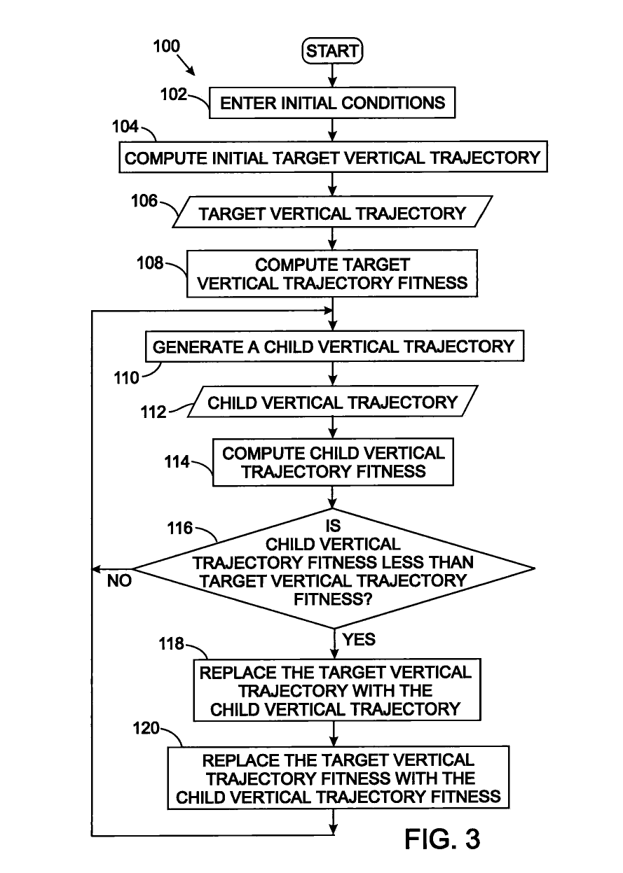

With reference to FIG. 3, the vertical trajectory algorithm 100 commences at step 102 when a new flight plan is entered into the FMS 12, along with the loaded weight of the aircraft, the quantity of fuel being carried, and the cruise altitude. From that data the mass of the aircraft and the mass of the fuel are calculated. Then at step 104, an initial solution for the target vertical trajectory is computed.

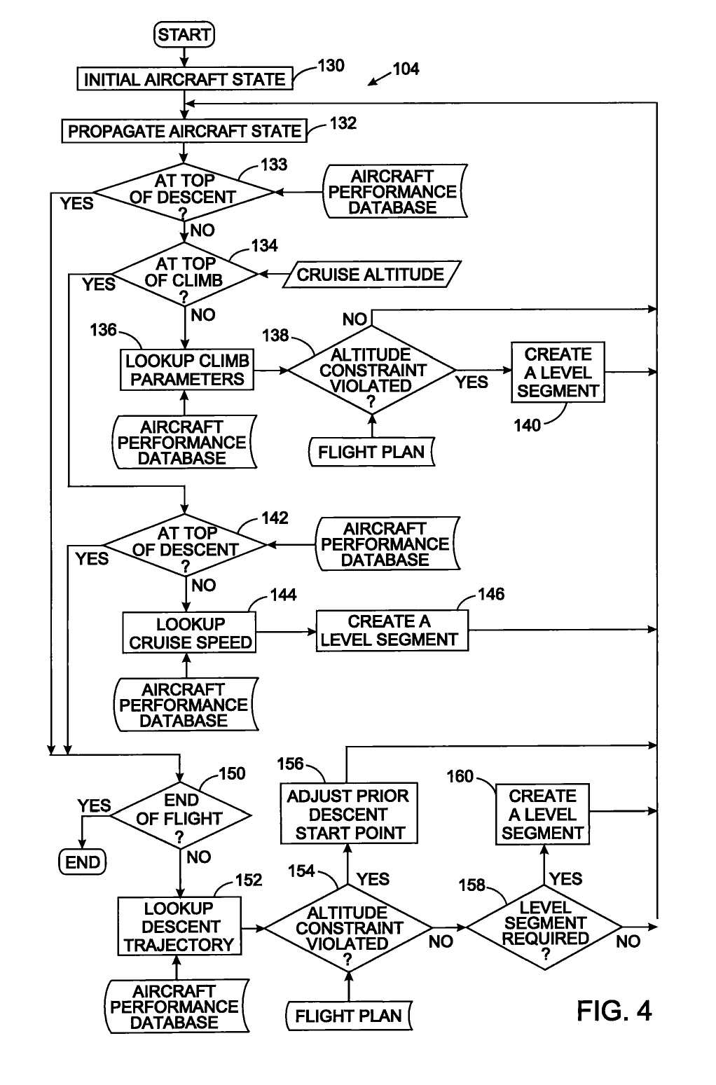

FIG. 4 illustrates the steps for deriving that initial solution and commences by obtaining the initial state of the aircraft prior to takeoff. A target vertical trajectory is then computed by repeatedly propagating the states of the aircraft at each of a sequence of fixed distance points along the planned route until the end of the flight is reached. The aircraft state at each of those distance points is defined by values for a set of operational and positional aircraft parameters comprising flight time, true air speed, aircraft mass, fuel flow rate, altitude, ground speed, flight path angle, excess thrust, flight path angle rate of change, and excess thrust rate of change. Excess thrust is the magnitude of the aggregate thrust provided by the engines minus the drag of the aircraft. The flight path angle rate of change and the excess thrust rate of change are used as the adjustable control parameters. Because the aircraft state is being propagated with respect to the along-track distance of the flight plan route, these rates are with respect to distance and not to time. It further should be understood that the aircraft states are calculated at known distance increments along the flight route and that incremental distance is used in deriving the aircraft state parameters. The following equations are solved by the FMS CPU 14 to derive values for some of those aircraft parameters:

$${t}^{′} = \frac{1}{{V}_{G}}$$

$${V}_{TAS}^{′} = \frac{1}{{V}_{G}} ( \frac{{T}_{ex}}{m} - g sin ( γ ) )$$

$${m}^{′} = \frac{1}{{V}_{G}} \dot{m}$$

$${H}^{′} = \frac{1}{{V}_{G}} {V}_{TAS} sin ( γ )$$

$${V}_{G} = {V}_{TAS} cos ( γ ) + wind$$

where t is time, V_{TAS} is the true air speed, m is the mass of the aircraft, \dot{m} is the fuel flow rate performance characteristic of the aircraft, H is the aircraft altitude, V_{G} is the ground speed, γ is the flight path angle, T_{EX} is the excess thrust, g is acceleration due to gravity, and wind is the magnitude of the wind speed in the along-track direction and comes from the flight plan weather information. It should be noted that The prime notation denotes a derivative with respect to distance and the dot notation denotes a derivative with respect to time. Thus, one set of these aircraft parameter values derived at step 132 represents the state of the aircraft at one of the distance points along the lateral flight path.

Next, at step 133 in FIG. 4, a check is made whether the aircraft has reached the top of descent point along the flight route. It is possible that this point can be reached before the aircraft attains the cruise altitude. In that event, the vertical trajectory computation step 104 jumps to step 150 for the descent phase. Typically that will not occur and the process advances to step 134.

At step 134, the projected altitude of the aircraft, as derived from the true airspeed and flight path angle, is compared to the cruise altitude designated in the flight plan to ascertain whether the aircraft has reached the top of its climb. If that is not the case, meaning that the aircraft is still in the climb phase, the target vertical trajectory computation advances to step 136. At this point, the processor 14 sets the excess thrust rate and flight path angle to the values for those parameters found in the database of aircraft performance characteristics. Then at step 138, an inspection is made whether the projected altitude violates any altitude constraint associated with the present distance point. If no violation is found, the trajectory computation returns immediately to step 132 to derive the positional and operational state parameters for the next distance point along the flight route. Otherwise, if an altitude constraint violation is found, the aircraft needs to enter level flight in order to mitigate that violation. To do so, the vertical trajectory computation creates a level flight segment at step 140 by setting the flight path angle to zero before advancing to step 132. The aircraft remains in such a level flight segment until a distance point is reached at which the altitude constraint violation no longer is found upon executing step 138. When that occurs, the target vertical trajectory returns to a climb by using the flight path angle obtained at step 136.

Steps 132-140 continue to be executed repeatedly until the aircraft is found at step 134 to have reached the top of climb point, as graphically illustrated in FIG. 2. The top of climb point occurs when the projected altitude equals the cruise altitude indicated in the flight plan.

At the top of climb point, the aircraft enters the cruise phase which continues until the target vertical trajectory reaches the distance along the flight route at which the top of descent point occurs. Thus when the top of climb point occurs, the initial target vertical trajectory computation step 104 advances to step 142 in FIG. 4. At this juncture, another check is made whether the aircraft has reached the top of descent point. Assuming that is not the case, the trajectory computation enters the cruise phase section in which the desired true air speed is obtained from the aircraft performance characteristic database at step 144. The cruise speed determines the fuel flow rate required to achieve that speed at the desired altitude and those values are used at step 146 to create a level flight segment that has a zero flight path angle (i.e., horizontal flight). The target vertical trajectory computation then returns to step 132 to propagate an aircraft state for the next incremental point along the flight route. Thus steps 132, 134, 142, 144, and 146 are executed repeatedly for each point that occurs during the cruise phase.

Eventually the target vertical trajectory computation reaches top of descent point at the end of the cruise phase. The initial location A in FIG. 2 for the top of descent is determined by the trajectory for an idle throttle descent and the distance at which the destination airport is located. As the name implies, an idle throttle descent is the trajectory that occurs when the aircraft throttle is set to the idle speed of the engines and the aircraft glides to the ground. The idle throttle descent trajectory is known from the aircraft performance characteristics in the FMS database. Thus the initial top of descent point is determined backwards by placing the bottom of the idle throttle descent trajectory at the location of the destination airport and the initial top of descent point A is the intersection of the idle throttle descent trajectory with the cruise altitude.

Upon reaching the distance point A that is defined as the initial top of descent, the computation process advances to step 150. An determination now is made whether the present distance point along the flight route is at the destination airport, i.e., the end of the flight, which initially is not the case. As a consequence, the computation process advances to step 152 at which idle throttle descent trajectory is obtained from the aircraft performance characteristics database. The most cost effective mode of descent occurs with the engines at idle speed, so that the aircraft glides to the ground along a trajectory depicted by the dashed line in FIG. 2. The idle throttle descent trajectory, however, typically cannot be used entirely because one or more of the waypoints in the descent phase has an altitude constraint that is violated by that descent trajectory. For example, the marked waypoint has a constraint that the aircraft altitude be within a given range denoted by the horizontal dotted lines. If the idle throttle descent trajectory was followed, the aircraft will be above the upper altitude limit at this waypoint. Therefore, in order use an idle throttle rate of descent for optimum economy and comply with the waypoint altitude constraint, the aircraft has to begin the descent earlier in the flight route at point B.

Nevertheless, the initial iterations of steps 132, 134, 142, 150, and 152-156 the trajectory computation process for the descent phase utilize the idle throttle descent trajectory (the dashed line) obtained from the aircraft performance characteristics database until the waypoint is reached. At each trajectory distance point iteration, the altitude derived from the idle throttle descent trajectory is checked at step 154 to determine whether an altitude constraint has been violated. If a present violation is not found and if no previous violations occurred during the descent phase, the trajectory computation advances from step 154 through step 158 back to step 132 where the aircraft state for the next incremental distance point along the flight route is derived.

With respect to the exemplary flight plan depicted in FIG. 2, eventually the trajectory computation for the descent phase reaches the illustrated waypoint. Because following the idle throttle descent trajectory will exceed the upper limit of the altitude constraint at the waypoint, a constraint violation will exist. As a result, the trajectory computation branches to step 156 at which the prior descent starting point is adjusted. In this case, the idle throttle descent trajectory, denoted by the dashed line, previously started at point A along the flight route, now that staring point is moved earlier in the target vertical trajectory by a small predefined amount in an attempt to avoid the waypoint altitude constraint violation. The designation of the current distance point being processed is reset to coincide with the new descent starting point, thereby returning the iterative process back to that distance point.

The resetting of the top of descent point in this manner may occur several times before the target trajectory does not violate the altitude constraint at the waypoint. This results in the target vertical trajectory, represented by the solid line in FIG. 2, which has a descent rate between the resultant top of descent point B and the waypoint that corresponds to the idle throttle descent rate. This optimizes the economy of the descent in this flight segment.

Nevertheless, the aircraft cannot continue at that rate of descent as doing so will intersect the ground before the destination airport. Therefore, the computed target vertical trajectory must return the aircraft to the idle throttle descent trajectory and does so by commencing a level flight segment at the waypoint. Thus, upon reaching the waypoint without finding a constraint violation at step 154, the trajectory computation process advance branches to step 158. At this time, the target trajectory point at the waypoint is found to be offset from the idle throttle descent trajectory, see FIG. 2. Since it is desirable to adhere to that idle throttle descent trajectory as much as possible, a decision is made at step 158 that a level segment is required to bring the aircraft back into a point of intersection with the idle throttle descent trajectory before further descent occurs. Thus the computation process branches to step 160 at which a level flight segment is created by setting the flight path angle to zero. Computation of the aircraft states at subsequent distance points continues this level flight segment until step 158 finds an intersection with the idle throttle descent trajectory at point C, i.e., level flight no longer is required.

The final target vertical trajectory depicted in the FIG. 2 example, however, does not reach the idle throttle descent trajectory at point C because at point D near the end of flight, the aircraft has to enter the predefined glide path for landing on the designated airport runway. As a consequence, the trajectory computation initially produces a solution that follows idle throttle descent trajectory. When that process reached distance point D, another altitude constraint violation is found because the altitude of the idle throttle descent trajectory does not equal the altitude required to commence the landing glide path. At that time, step 156 adjusts the location of point C, by setting that start of descent point earlier in the flight plan so that the computed target vertical trajectory coincides with the glide path at distance point D.

The target vertical trajectory computation continues until deriving the aircraft state for the distance point on the runway at destination airport. The resultant target vertical trajectory comprises the sequence of sets of aircraft positional and operational parameter values indicating the state of the aircraft at each incremental distance point along the flight route. That parameter data are stored in the memory 16 of the FMS 12.

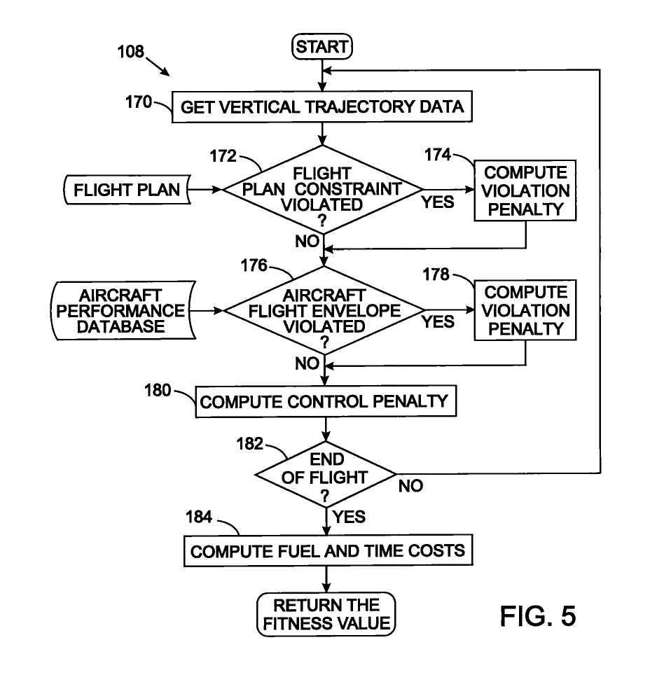

Returning again to FIG. 3, the result of the initial trajectory computation at step 104 becomes the target vertical trajectory 106. The vertical trajectory algorithm 100 at step 108 then evaluates the relative merits of the target vertical trajectory, referred to herein as calculating its fitness which produces a fitness value. FIG. 5 is a flowchart of the fitness evaluation that is conducted at step 108. The evaluation commences at step 170 by the FMS CPU 14 obtaining the trajectory data for the most recently computed target vertical trajectory. Thereafter, a pass through the evaluation routine is conducted for each distance point along the flight route and the aircraft parameters at each distance point are analyzed for compliance with flight plan constraints and other factors.

In each pass, a determination is made at step 172, whether the aircraft parameters at the distance point presently being evaluated violate any constraint specified in the flight plan. Those constraints comprise altitude, time of arrival at the distance point, and speed of the aircraft. If a violation is found, the fitness evaluation branches to step 174 to compute a numerical violation penalty based on the type and magnitude of that violation. Any new numerical violation penalty is added to an aggregate violation penalty for the target vertical trajectory being evaluated. Although the derivation of the target vertical trajectory took into account only the flight plan altitude constraints and ignored any speed and time constraints, this evaluation step 174 factors in any such speed and time constraints. Therefore, after all the distance points for the target vertical trajectory have been evaluated, the aggregate violation penalty reflects how well that trajectory conforms with all the fundamental flight constraints of altitude, speed, and time.

Next, at step 176, a determination is made whether the aircraft flight, or performance, aircraft flight envelope is violated at the present distance point. The flight envelope, also known as the performance envelope, is based on the aircraft performance characteristics stored in the FMS memory 16 and specifies the operating and performance capabilities of the particular aircraft. An envelope violation occurs if an operational parameter value of the proposed vertical trajectory does not conform to the aircraft performance capabilities. In other words, the target vertical trajectory requires the aircraft to perform in a manner that is beyond the capability of the aircraft. This type of violation also may be defined as occurring when the proposed vertical trajectory requires that the aircraft perform in a capable, but undesirable manner, such as a maneuver that would be distressing to passengers, for example. Thus an envelope violation broadly occurs when the vertical trajectory being evaluated requires that the aircraft perform in an undesirable or impossible manner. Such a violation causes the evaluation process 108 to apply a very large numerical violation penalty at step 178, which subsequently causes the vertical trajectory algorithm 100 to reject the target vertical trajectory being evaluated. In should be understood that the initial target vertical trajectory by definition complies with the aircraft performance characteristics because the aircraft performance database was used to produce that trajectory. Subsequent derivations of alternative target vertical trajectories, however, can result in an envelope violation. Any envelope violation penalty is added to the aggregate violation penalty.

The evaluation process then advances to step 180 at which a control penalty is assessed based on the number of times the excess thrust changes or the aircraft angle is altered during the target vertical trajectory being evaluated. This imparts a preference for trajectories that provide a relatively smooth flight. Any control penalty is added to the aggregate violation penalty.

Steps 170-180 are executed repeatedly for each distance point of the target vertical trajectory. A determination is made at step 182 whether this iterative process has reached the end of the flight, that is, evaluated the last distance point that is at the destination airport. If that is not the case, the process loops back to step 170 to evaluate the next distance point. Eventually the evaluation process reaches the end of flight and advances to step 184 at which the projection of the total amount of fuel consumed is used to calculate a fuel cost and the total flight time determines a time cost in monetary units. Conventional cost indices are employed to calculate these monetary costs. The magnitudes of the fuel and times costs than determine additional numerical penalty values that are added to the aggregate violation penalty, which thereby becomes an indication of the relative fitness of a vertical trajectory. Alternatively, the fuel and times costs can be used directly as indications of the vertical trajectory fitness.

After the initial target vertical trajectory has been computed and its fitness analyzed, the vertical trajectory algorithm 100 in FIG. 3 enters a section in which the aircraft parameters along the target vertical trajectory are randomly altered (i.e. mutated) to create an alternative target vertical trajectory, referred to as a child trajectory. The fitness of the child vertical trajectory is computed and compared to the fitness of the target vertical trajectory. If the child has better fitness, it replaces the previous target vertical trajectory; otherwise, the previous target vertical trajectory remains intact. This child vertical trajectory generation process then repeats continuously thereby producing random children in order to obtain the optimum target vertical trajectory, i.e., one having the most robust fitness.

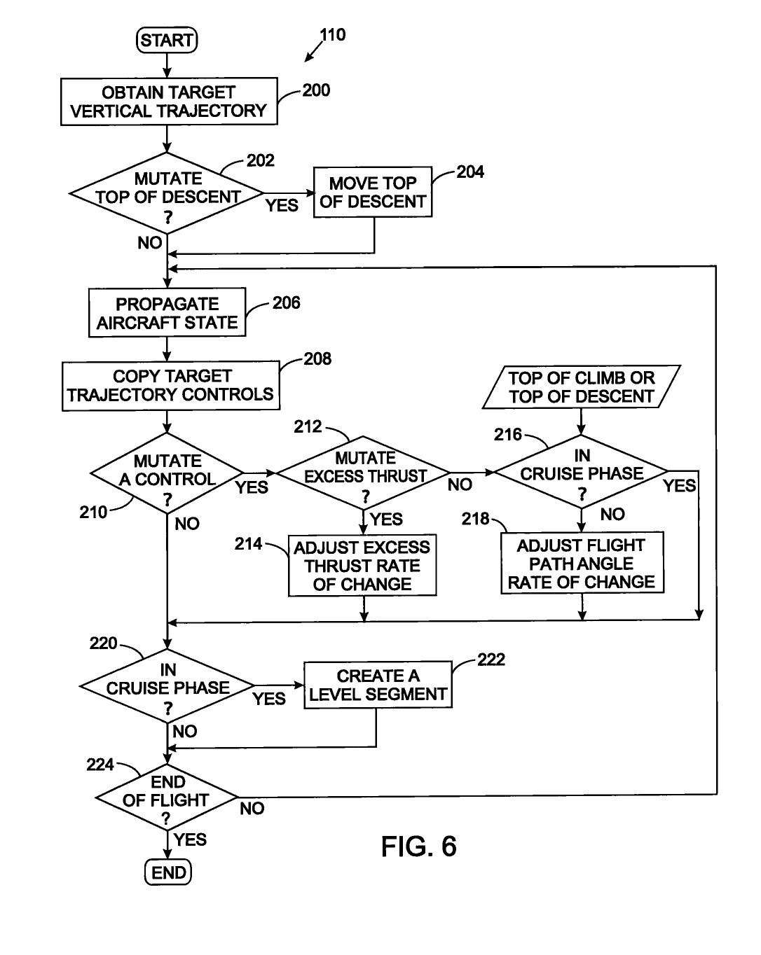

This iterative section of the vertical trajectory algorithm 100 commences at step 110 in which the present target vertical trajectory is mutated repeatedly to generate a series of children vertical trajectories. FIG. 6 depicts the steps for generating one child vertical trajectory and starts with step 200 where the data for the present target vertical trajectory are obtained. Then at step 202, a decision is made whether to mutate, i.e., alter, the location of the top of descent. Each time a child vertical trajectory is generated, the particular parameters of the target vertical trajectory to be altered are randomly determined. For example, a random number can be generated by the FMS CPU 14 and the decision to alter a given parameter is based on that number being within a predefined range of values. The size of that range determines the frequency that a given parameter at anyone of the distance points will be altered. Because the top of descent point is relatively influential on the costs associated with the descent of the aircraft, mutation of its location along the flight route occurs in only a small percentage of the children trajectories that are generated, i.e., for a small range of random numbers. If a determination is made to mutate the top of descent, the process branches to step 204 at which the location of the top of descent in the target vertical trajectory is moved a fixed amount in one direction or the other, again depending upon the value of the random number.

The child vertical trajectory generation process 110 then advances to step 206 at which a loop commences that computes the aircraft state at each of the distance points along the flight route. The first pass through the loop computes the operational and positional aircraft parameters for the first distance point in the same manner as stated above with respect to the initial target vertical trajectory.

Then at step 208, the values for the trajectory control parameters of flight path angle rate of change and excess thrust rate of change for the next distance point are obtained from the target vertical trajectory data and a decision is made at step 210 whether to mutate those trajectory control values. That decision is made randomly, such for example as based on a randomly generated number as described before. If the decision is positive, the generation process for a child vertical trajectory branches to step 212 at which the randomly generated number is inspected to determine whether it indicates that the excess thrust control parameter should be mutated. If so, the excess thrust value rate of change is adjusted by a fixed amount at step 214 and the algorithm advances to step 220.

Otherwise if at step 212 the excess thrust rate of change is not to be altered, the child generation advances to step 216 in which a determination is made whether the distance point along the flight route occurs during the cruise phase. This determination is made by evaluating the flight plan distance points for the top of climb and top of descent. If the aircraft is in either the climb or descent phases, the child generation algorithm branches to step 218 where the flight plan angle rate of change control from the target vertical trajectory is adjusted before advancing to step 220. If, however, the present distance point occurs during the cruise phase, the flight path angle is not adjusted so that level flight continues.

At step 220, another determination is made whether the present distance point occurs in the cruise phase, in which case a level flight segment is created at step 222. This pair of steps is necessary to accommodate the first distance point after the top of climb point at which the vertical trajectory enters the cruise phase and level flight. Another determination then is made at step 224 whether the present distance point occurs at the end of the flight. If not, the generation process for a child vertical trajectory returns to step 206 to propagate the aircraft state for the next distance point along the flight route. The child vertical trajectory generation step 110 ends upon processing all the distance points along the flight route.

The completion of step 110 produces a child vertical trajectory 112 in FIG. 3. Execution of the vertical trajectory algorithm 100 then advances to step 114. At this juncture, the fitness of the newly created child vertical trajectory 112 is evaluated by executing the routine in FIG. 5 that was described previously which produces a child fitness value. Then at step 116, the fitness of the child vertical trajectory is compared to that of the target vertical trajectory to determine whether the child has a more robust fitness, that is, a lower aggregate penalty value and/or lower fuel and time costs. If the child has a better fitness, the child vertical trajectory replaces the previous target vertical trajectory at step 118, thereby becoming a new target vertical trajectory and at step 120 the indication of the child vertical trajectory fitness becomes the indication of the target vertical trajectory fitness. Otherwise at step 116, if the child vertical trajectory does not have the better fitness, the previous target trajectory remains unchanged for subsequent use. In this manner, the target vertical trajectory at any point in time is the vertical trajectory that has been determined to be the most robust of all the trajectories that have been created and evaluated.

The iterative vertical trajectory algorithm 100 then returns to step 110 to generate another child vertical trajectory and determine whether it is more robust that the current target vertical trajectory. The vertical trajectory algorithm runs continuously during the aircraft flight. Alternatively, the vertical trajectory algorithm 100 could be executed a predefined number of times or until a predefined event occurs. Any time that the flight management system 12 requires information regarding the vertical trajectory for the aircraft, data from the then current target vertical trajectory is used.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. A method for producing a target vertical trajectory for an aircraft flight route comprising:
(a) providing a database of aircraft performance characteristics;
(b) defining the aircraft flight route having at least one waypoint;
(c) producing a target vertical trajectory by deriving a set of values for a plurality of aircraft parameters at each of a plurality of points along the aircraft flight route;
(d) evaluating fitness of the target vertical trajectory using a predefined criteria;
(e) producing a child vertical trajectory by altering the value of at least one of the plurality of aircraft parameters for selected points along the aircraft flight route in the target vertical trajectory;
(f) assessing fitness of the child vertical trajectory using the predefined criteria;
(g) if the child vertical trajectory has a better fitness than the target vertical trajectory, then defining the child vertical trajectory as the target vertical trajectory; and
(h) repeating steps (e) through (g) for a plurality of times.

2. The method as recited in claim 1 wherein the plurality of aircraft parameters, comprises excess thrust rate of change and flight path angle rate of change.

3. The method as recited in claim 2 wherein producing a child vertical trajectory comprises randomly altering the excess thrust rate of change and the flight path angle rate of change obtained for selected points along the aircraft flight route in the target vertical trajectory.

4. The method as recited in claim 1 wherein the plurality of aircraft parameters, include one or more of flight time, true air speed, aircraft mass, fuel flow rate, altitude, ground speed, flight path angle, excess thrust, flight path angle rate of change, and excess thrust rate of change.

5. The method as recited in claim 1 wherein the database of aircraft performance characteristics includes data for a fuel flow rate.

6. The method as recited in claim 1 wherein at least some of the waypoints have a flight constraint; and wherein evaluating fitness comprises determining whether the target vertical trajectory violates any flight constraint; and wherein assessing fitness comprises determining whether the child vertical trajectory violates any flight constraint.

7. The method as recited in claim 6 wherein evaluating fitness and assessing fitness comprises assigning a numerical value to each violation of a flight constraint.

8. The method as recited in claim 6 wherein evaluating fitness and assessing fitness comprises assigning fuel and time monetary costs in response violation of flight constraints.

9. The method as recited in claim 1 wherein evaluating fitness comprises determining whether the target vertical trajectory contains an aircraft parameter value that fails to conform to the aircraft performance characteristics; and assessing fitness comprises determining whether the child vertical trajectory contains an aircraft parameter value that fails to conform to the aircraft performance characteristics.

10. The method as recited in claim 1 wherein:
evaluating fitness comprises determining a number of times that the target vertical trajectory changes at least one of an excess thrust rate of change and a flight path angle rate of change; and
assessing fitness comprises determining a number of times that the child vertical trajectory changes at least one of excess thrust rate of change and the flight path angle rate of change.

11. The method as recited in claim 1 database of aircraft performance characteristics includes data specifying an idle throttle descent trajectory.

12. The method as recited in claim 1 wherein producing a target vertical trajectory further comprises defining a top of descent location along the flight route at which the target vertical trajectory begins a descent to land at a destination airport.

13. The method as recited in claim 12 wherein defining a top of descent location comprises:
employing an idle throttle descent trajectory for the aircraft to define the top of descent location;
determining whether the idle throttle descent trajectory results in a violation of any flight constraint; and
if a violation is found, moving the top of descent location and redefining a segment of the target vertical trajectory during the descent phase.

14. A method for producing a target vertical trajectory for an aircraft comprising:
providing a database of aircraft performance characteristics;
defining a flight plan that comprises a flight route having waypoints there along at which a constraint based on at least one of altitude, speed, and time is specified;
producing a target vertical trajectory by deriving a set of values a plurality of aircraft parameters at each of a plurality of points along the aircraft flight route;
evaluating fitness of the target vertical trajectory by determining whether the target vertical trajectory violates any constraint of the flight plan, which thereby produces a target fitness indication; and
revising the target vertical trajectory by iteratively performing a sequence of steps comprising:
(a) producing a child vertical trajectory by randomly altering the value of at least one of the a plurality of aircraft parameters for selected points along the aircraft flight route in the target vertical trajectory,
(f) assessing fitness of the child vertical trajectory by determining whether the child vertical trajectory violates any constraint of the flight plan, which thereby produces a target fitness indication, and
(g) comparing the target fitness indication to the child fitness indication to determine whether the child vertical trajectory has a better fitness, in which case the child vertical trajectory becomes the target vertical trajectory.

15. The method as recited in claim 14 wherein the plurality of aircraft parameters, comprises excess thrust and flight path angle.

16. The method as recited in claim 15 wherein producing a child vertical trajectory comprises randomly altering a rate of change of the excess thrust and a rate of change of the flight path angle obtained for selected points along the aircraft flight route in the target vertical trajectory.

17. The method as recited in claim 14 wherein the plurality of aircraft parameters, include one or more of flight time, true air speed, aircraft mass, fuel flow rate, altitude, ground speed, flight path angle, excess thrust, flight path angle rate of change, and excess thrust rate of change.

18. The method as recited in claim 14 wherein the database of aircraft performance characteristics includes data for a fuel flow rate.

19. The method as recited in claim 14 wherein evaluating fitness and assessing fitness comprises assigning a numerical value to each violation of a constraint of the flight plan.

20. The method as recited in claim 14 wherein evaluating fitness and assessing fitness comprises assigning fuel and time monetary costs in response violation of flight constraints.

21. The method as recited in claim 14 wherein evaluating fitness further comprises determining whether the target vertical trajectory contains an aircraft parameter value that fails to conform to the aircraft performance characteristics; and determining whether the child vertical trajectory contains an aircraft parameter value that fails to conform to the aircraft performance characteristics.

22. The method as recited in claim 14 wherein evaluating fitness further comprises determining a number of times that the target vertical trajectory changes at least one of an excess thrust rate of change and a flight path angle rate of change; and assessing fitness further comprises determining a number of times that the child vertical trajectory changes at least one of excess thrust and the flight path angle.

23. The method as recited in claim 14 database of aircraft performance characteristics includes data specifying an idle throttle descent trajectory.

24. The method as recited in claim 14 wherein producing a target vertical trajectory further comprises defining a top of descent location along the flight route at which the target vertical trajectory begins a descent to land at a destination airport.

25. The method as recited in claim 24 wherein defining a top of descent location comprises:
employing an idle throttle descent trajectory for the aircraft to define the top of descent location;
determining whether the idle throttle descent trajectory results in a violation of any flight constraint; and
if a violation is found, moving the top of descent location and redefining a segment of the target vertical trajectory during the descent phase.
